(19) United States
(12) Patent Application Publication
(10) Pub. No.: US 2022/0366519 A1
(43) Pub. Date: Nov. 17, 2022

(54) METHOD OF PROVIDING REAL ESTATE TRANSACTION PLATFORM THAT SUPPORTS DIRECT TRANSACTIONS BETWEEN SELLERS AND BUYERS

(71) Applicant: YBnetworks Co., Ltd., Seoul (KR)

(72) Inventor: Youngdoo SON, Seoul (KR)

(21) Appl. No.: 17/739,139

(22) Filed: May 8, 2022

(30) Foreign Application Priority Data
May 13, 2021 (KR) 10-2021-0061694

(51) Int. Cl. G06Q 50/16; G06Q 20/10; G06Q 20/40

(52) U.S. Cl. CPC G06Q 50/16; G06Q 20/102; G06Q 20/4014

(57) ABSTRACT

The operation of the real estate platform in the present invention comprises of: the transmission of the seller's and the buyer's personal information from their terminals to the main server; the uploading of the information of the real estate for sale from the seller's terminal onto the main server; the request of the buyer's terminal to the main server for the information of the real estate for sale and the receipt such information; the selection of the information of specific real estate for sale from the buyer's terminal from the list of the real estate for sale; the generation of chatting room by the main server for the seller's and the buyer's terminals; the transmission of the agreement information from the seller's and the buyer's terminals to the main server and the request of the contract process; the processing of the seller's and the buyer's personal information and the information of the specific real estate for sale by the main server and the provision of a modifiable electronic agreement to the seller's and the buyer's terminals; and the receipt of the credential information by the main server from the seller's and the buyer's terminals, the credential process, and the conclusion of the contract after the seller's and the buyer's signatures are affixed by their respective terminals.

### CROSS-REFERENCE TO RELATED APPLICATIONS

A claim for priority under 35 U.S.C. § 119 is made to Korean Patent Application No. 10-2021-0061694 filed May 13, 2021, in the Korean Intellectual Property Office, the entire contents of which are hereby incorporated by reference.

### BACKGROUND

The present invention provides the method of operation of a real estate transaction platform that supports the direct transactions between the sellers and the buyers.

A real estate transaction refers to the legal acts of selling, purchasing, or leasing real estate, including, but not limited to, land or buildings, performed by the seller (lesser) and the buyer (lessee) through sales, lease, or rent agreements.

However, real estate transactions comprise various legal items that need to be identified from the time transactions start to the time they conclude, and general transacting parties, who usually have no professional knowledge of the transaction, usually commission qualified realtors for the transaction services.

Nevertheless, transactions performed with the services rendered by qualified realtors add brokerage to the costs, may not actively reflect the disposition of the transacting party, and may only have limited information about the real estate offered for sale by the qualified realtors. Moreover, at the early steps of the transactions, the transacting parties face difficulties in making direct communication without the intervention of the qualified realtors.

Various real estate transaction platforms are being researched and developed to solve these problems; however, the existing models lack devices to legally protect transaction parties from sales of the estate to multiple buyers and unreasonably high lease deposits, and the qualified realtors still perform the final agreement preparation and signing.

### SUMMARY

The present invention provides an operation method for the real estate transaction platform that supports the direct transactions by the sellers and the buyers from the beginning to the end of the real estate transactions without the interventions of the qualified realtors, legally protects the transacting parties, and removes the inconvenience of formal acts that non-professionals may face in order to prepare the agreement.

The problems that the present invention tries to solve are not limited to those stated above, and one having ordinary skills in the art will be able to clearly understand the other unmentioned problems through the descriptions written below.

To solve the problem mentioned above, the operation of the real estate platform in the present invention comprises the transmission of the seller's and the buyer's personal information from their terminals to the main server; the uploading of the information of the real estate for sale from the seller's terminal onto the main server; the request of the buyer's terminal to the main server for the information of the real estate for sale and the receipt such information; the selection of the information of specific real estate for sale from the buyer's terminal from the list of the real estate for sale; the generation of chatting room by the main server for the seller's and the buyer's terminals; the transmission of the agreement information from the seller's and the buyer's terminals to the main server and the request of the contract process; the processing of the seller's and the buyer's personal information and the information of the specific real estate for sale by the main server and the provision of a modifiable electronic agreement to the seller's and the buyer's terminals; and the receipt of the credential information by the main server from the seller's and the buyer's terminals, the credential process, and the conclusion of the contract after the seller's and the buyer's signatures are affixed by their respective terminals.

In the event that the buyer's terminal transmits messages requesting the confirmation of payment to the seller's terminal through the main server, the present invention further comprises the issuance, and the save of the transfer confirmation slip by the main server.

The present invention further comprises the receipt of the registration application data from the seller's and the buyer's terminals by the main server and the notification of the completion of the registration application.

In the event that the buyer's terminal requests the review of the electronic agreement to the main server, the present invention further comprises the primary review of the electronic agreement in the main server using an automatic review program and the request for the secondary review to the manager's terminal for the provision of the results of the review to the buyer's terminal.

The present invention comprises the access to the public server by the main server to receive information on the register of the real estate for sale, the processing of the seller's and the buyer's personal information, and the information of the specific real estate for sale, as well as the register information, and the provision of the electronic agreement to the seller's and the buyer's terminals.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 illustrates an operational flow diagram of the real estate transaction platform process in the present invention.

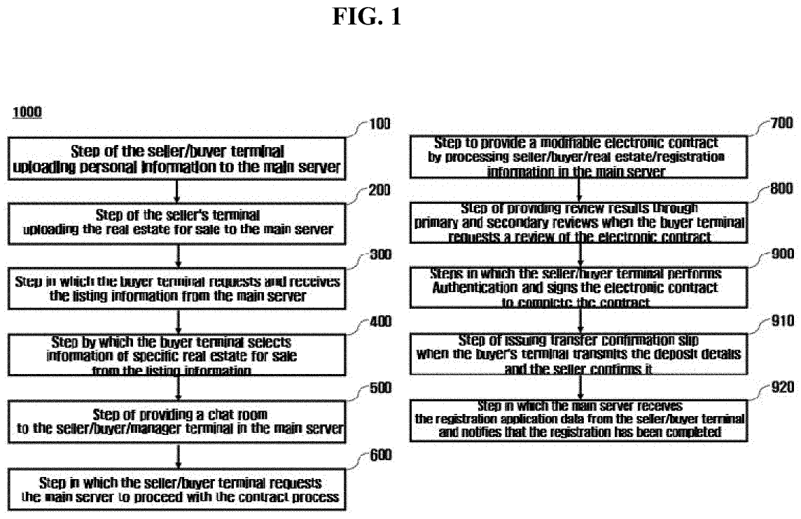

FIG. 2 illustrates a block diagram that depicts the system used in the operation of the real estate transaction platform in the present invention.

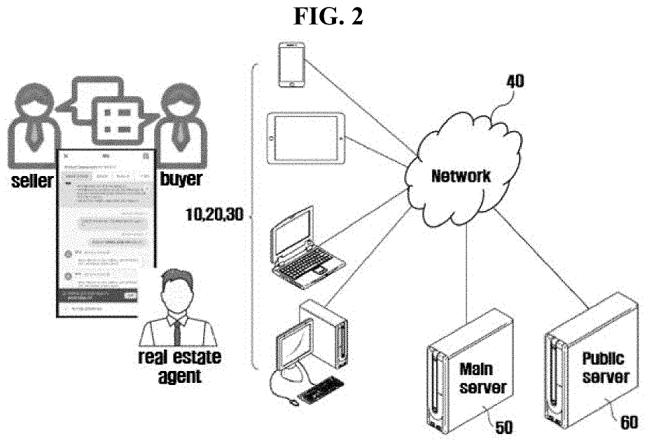

FIG. 3 illustrates a flow diagram of the process in the first modification of the real estate transaction platform in the present invention.

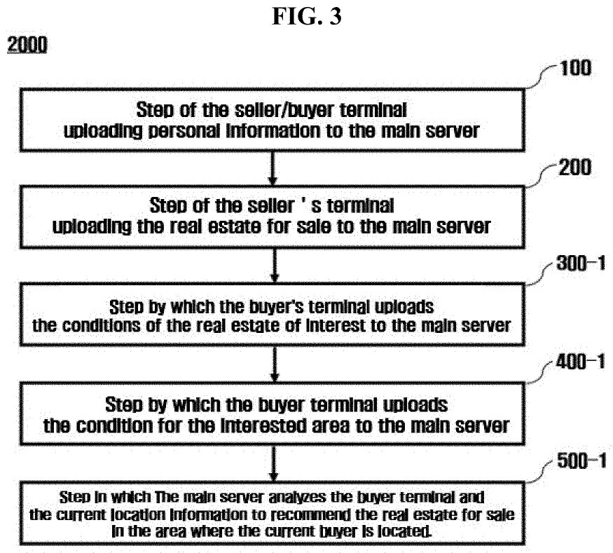

FIG. 4 illustrates a block diagram that depicts the system used in the operation of the first modification of the real estate transaction system in the present invention.

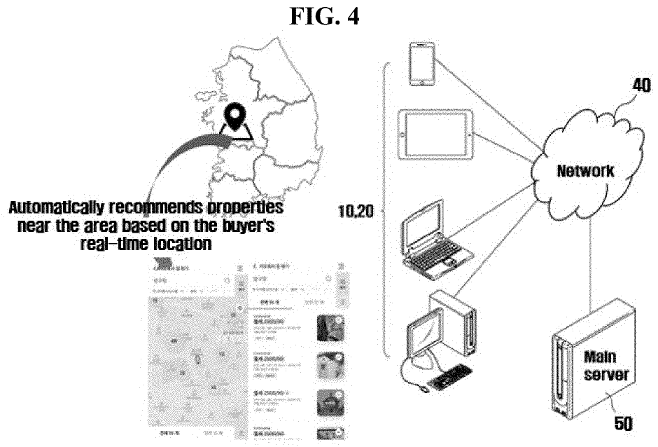

FIG. 5 illustrates a conceptual diagram that depicts the recommendation of real estate for sale using the buyer's location information in the first modification of the real estate transaction platform in the present invention.

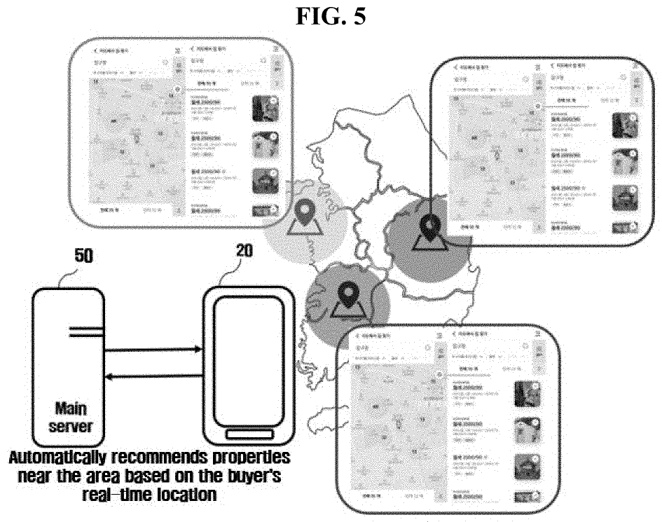

FIG. 6 illustrates a conceptual diagram that depicts real estate recommendation for sale according to the buyer's settings in the first modification of the real estate transaction platform in the present invention.

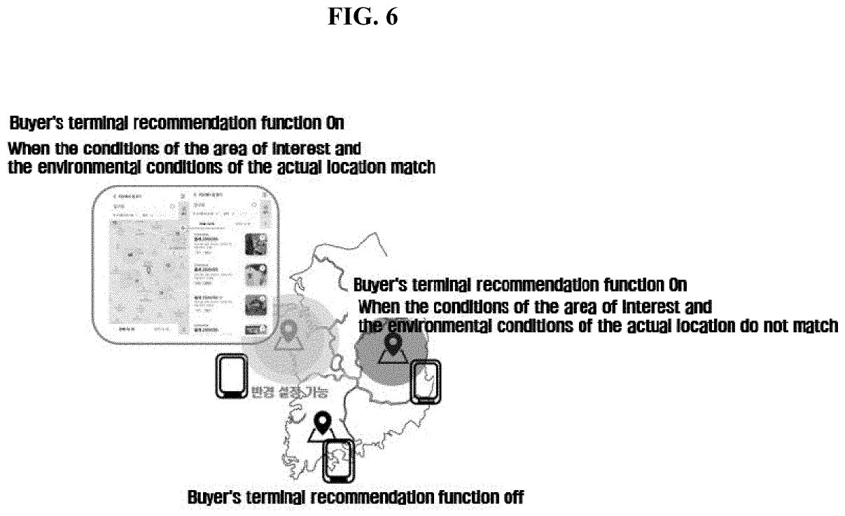

FIG. 7 illustrates a flow diagram of the process in the second modification of the real estate transaction platform in the present invention.

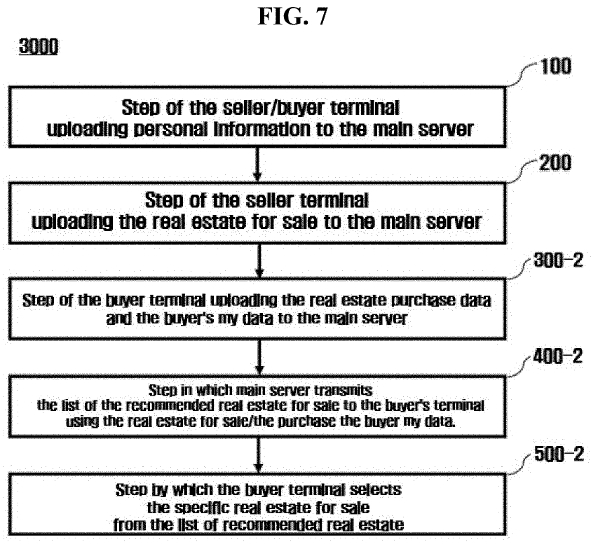

FIG. 8 illustrates a block diagram that depicts the system used in the operation of the second modification of the real estate transaction system in the present invention.

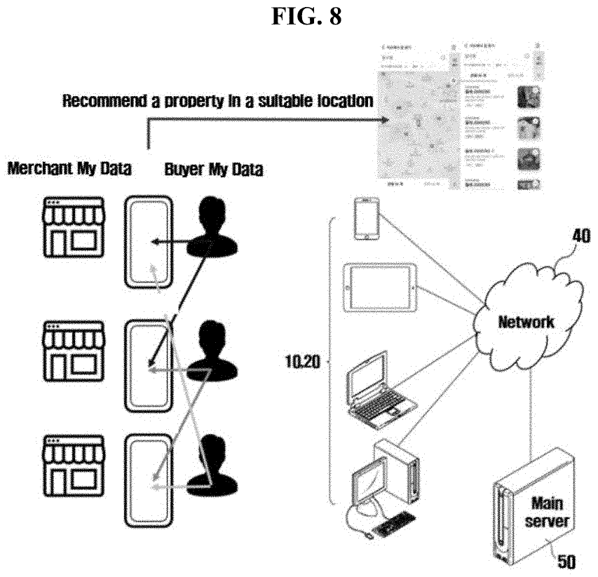

FIG. 9 illustrates a conceptual diagram that depicts the creation of recommended real estate for sale using the buyer's My Data in the second modification of the real estate transaction platform in the present invention.

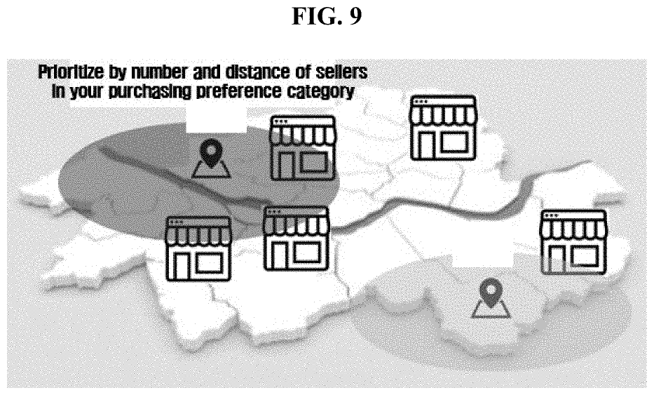

FIG. 10 illustrates a conceptual diagram that depicts the creation of recommended real estate for sale using the seller's My Data in the second modification of the real estate transaction platform in the present invention.

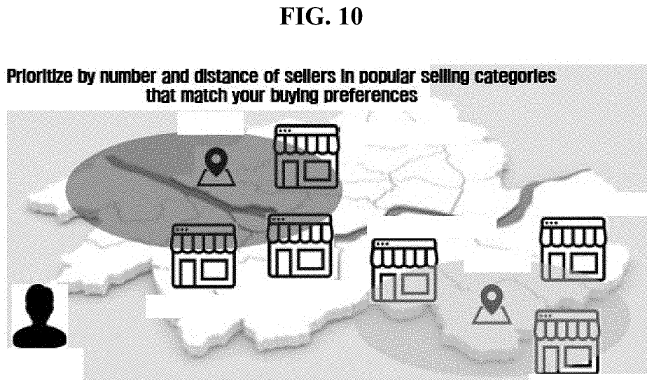

FIG. 11 illustrates a flow diagram of the process in the third modification of the real estate transaction platform in the present invention.

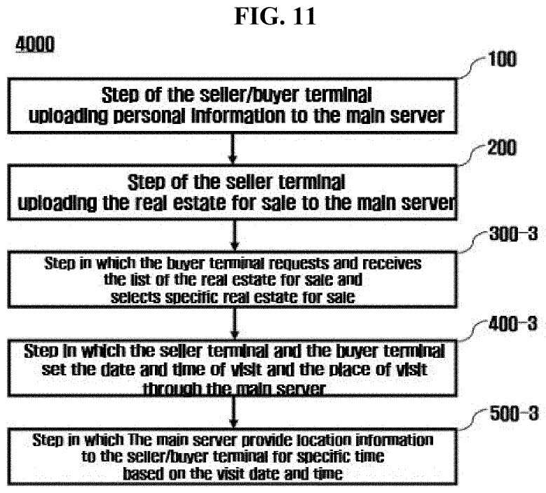

FIG. 12 illustrates a block diagram that depicts the system used in the operation of the third modification of the real estate transaction system in the present invention.

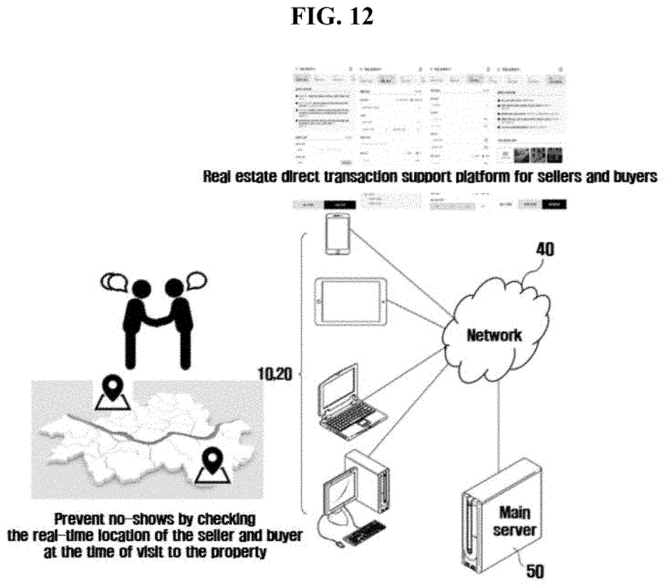

FIG. 13 illustrates a conceptual diagram that depicts the real-time confirmation of the location of the seller and the buyer on the date of visit in the third modification of the real estate transaction platform in the present invention.

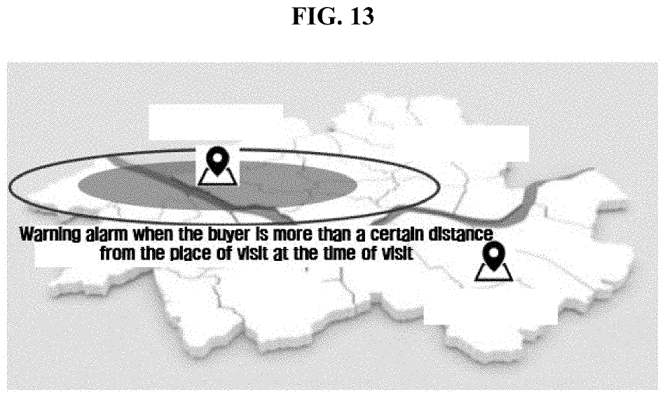

FIG. 14 illustrates a conceptual diagram that depicts verifying the seller's and the buyer's identities using a video call on the date of visit in the third modification of the real estate transaction platform in the present invention.

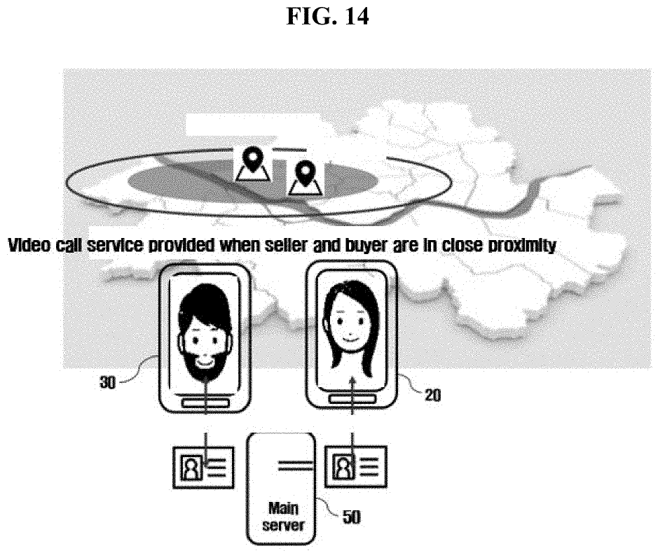

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

The operation of the real estate transaction platform (1000) in the present invention may be performed within a system that comprises a seller's terminal (10), a buyer's terminal (20), a manager's terminal (30), a network (40), the main server (50), and a public server (60).

A seller's terminal (10), a buyer's terminal (20), and a manager's terminal (30) may be a terminal that provides the webpage, app page (app list), program, or application related to the operation of the real estate transaction platform (1000) in the present invention.

In this case, the seller's terminal (10), the buyer's terminal (20), and the manager's terminal (3) may be realized by computers that can connect and access the remote main server (50) through the network (40).

In detail, the seller's terminal (10), the buyer's terminal (20), and the manager's terminal (30) may be wireless communication devices that may include without limitation the handheld wireless communication devices including, but not limited to, GPS (Global Positioning System), PCS (Personal Communication System), GSM (Global System for Mobile Communications), PDC (Personal Digital Cellular), PHS (Personal Handyphone System), PDA (Personal Digital Assistant), IMT (International Mobile Communication)-2000, CMDA (Code Division Multiple Access)-2000, W-CDMA (W-Code Division Multiple Access), Wibro (Wireless Broadband Internet) terminal, smartphone, smart pad, and tablet PC and ordinary desktop PC.

A network (40) refers to the connections that allow the information exchange between each node, including, but not limited to, the seller's terminal (10), the buyer's terminal (20), the manager's terminal, the main server (50) and the public server (60), and the network used herein includes without limitation the RF, 3GPP (3rd Generation Partnership project) network, LTE (Long Term Evolution) network, 5GPP (5th Generation Partnership Project) network, WiMAX (World Interoperability for Microwave Access) network, the Internet, LAN (Local Area Network), Wireless LAN (Wireless Local Area Network), WAN (Wide Area Network), PAN (Personal Area Network), Bluetooth network, NFC network, satellite broadcasting network, an analog broadcasting network, and DMB (Digital Multimedia Broadcasting) network.

The main server (50) may refer to the server that provides the web page, app page, program, or application related to the operation of the real estate transaction platform (1000) in the present invention.

A public server (60) refers to the database servers installed at various public institutions, including, but not limited to, administrative offices, courts, and registrar's offices; it may be a server that stores various public data related to the operation of the real estate transaction platform (1000) in the present invention or the one that provides the webpage, app page, program or application related to the operation thereof.

Public data refers to the dataset owned by a state that is open to the public in accordance with the relevant laws (the Act on Promotion of the Provision and Use of Public Data in the Republic of Korea) and provided to allow easier sharing and utilization of such data.

A public server (60) may transmit information to and from the main server (50) via a network (40); hence, the main server (50) may receive various administrative documents from the sellers' terminal (10), the buyer's terminal (20), and the manager's terminal (30) in the form of data and process administrative acts through a public server (60).

The operation of the real estate transaction platform (1000) in the present invention comprises the following steps:

The transmission of the “seller's personal information” and the “buyer's personal information” from the seller's terminal (10) and the buyer's terminal (20) to the main server (50) may be the step (100) where the seller and the buyer download and register the real estate transaction platform and the seller and the buyer may enter and transmit their personal information (including, but not limited to, names and contact details) to the main server (50). In this step, the present invention allows the users to register the platform program with simple personal information in order to enhance the accessibility to the platform.

On the other hand, this step in the operation of the real estate transaction platform (1000) in the present invention may be modified to perform a simple mobile identification using the seller's and the buyer's personal information.

The uploading of the information from the real estate for sale (also referred to as the real estate for sale, real estate for sale data) from the seller's terminal (10) onto the main server (50) may refer to the step (200) where the seller enters the information about the real estate for sale; in detail, the seller may upload the information about the address, the level, and the room number of the real estate and the agreement terms (including, but not limited to, the sales agreement, lease agreement, jeonse agreement, sales amount, rent amount, and deposit amount), administrative information on the real estate, including, but not limited to, the confirmation of resident household and register information, and the information on various amenities and facilities (furnishing of air conditioners, washing machines, furniture and parking lots) to the main server (50).

The request of the buyer's terminal to the main server (50) for the “information of the real estate for sale” and the receipt of such information may refer to the step (300) where the buyer enters the information of the real estate for sale that he/she seeks and receives curated offer lists from the main server (50).

In such case, the buyer may enter the information about the address, the level, and the room number of the real estate and the agreement terms (including, but not limited to, the sales agreement, lease agreement, jeonse agreement, sales amount, rent amount, and deposit amount), administrative information on the real estate, including, but not limited to, the confirmation of resident household and register information, and the information on various amenities and facilities (furnishing of air conditioners, washing machines, furniture and parking lots) to the main server (50).

Moreover, the main server (50) may provide the buyer's terminal (20) with the personality type test (such as MBTI) and reflect the “outcomes of the personality type test” performed on the buyer's terminal (20) alongside the above information entered in the buyer's terminal (20) to provide the buyer's terminal (20) the list of real estate for sale using the preset curating program.

In addition, the main server (50) may access the public server (60) to receive the social safety index corresponding to the location of the real estate for sale (provided by the Money Today, Sungshin Women's University Data Science Center, K-Stat Research, and PMI; information includes without limitation the disaster management information, public facility safety information, information on the safety of drinking water, indoor air quality information, female crime occurrence information, women and family panel research information) alongside the list of real estate for sale that will be sent to the buyer's terminal (20).

Furthermore, the buyer's terminal (20) will be able to display “information of multiple real estates of interest for sale” selected from the list of real estate for sale in parallel on a single screen (including the app image), and the buyer will be able to take advantage of comparing “information of multiple real estates of interest for sale” en bloc.

The selection of the “information of specific real estate for sale” from the buyer's terminal (20) from the “list of real estate for sale” may refer to the step (400) where the buyer chooses specific real estate for sale, among the list of real estate for sale provided from the main server (50), that is consistent with his/her conditions. In such a case, the main server (50) may provide the seller's terminal (10) a push notification informing that a specific buyer has chosen his/her real estate for sale.

The generation of a chatting room by the main server (50) for the seller's terminal (10), the buyer's terminal (20), and the manager's terminal (30) may refer to the step (500) where the main server generates a chatting room where the seller and the buyer may communicate about the real estate for sale and the personal information under the consent of the parties.

The seller and the buyer may send and receive text, voice, and video messages in real-time through the chatting room and may also request to disclose their phone numbers. Furthermore, the seller and the buyer may coordinate the date of visit to the real estate for sale by mutual agreement, and the confirmed date of visit may be automatically recorded in the calendar of the seller's terminal (10) and the buyer's terminal (20).

On the other hand, the owner of the manager's terminal may be a platform operator or a qualified realtor with professional knowledge in real estate transactions. The manager's terminal may join the chatting room under the authority of the operator or at the request of the seller and the buyer.

As such, the seller and the buyer may inquire the manager for the general information about the real estate for sale and legal problems; therefore, the parties may safely and legitimately proceed with the transaction process, and the system may also secure the user convenience.

The transmission of the “agreement information” from the seller's terminal (10) and the buyer's terminal (20) to the main server (50) and the request of the contract process may be the step (600) where the seller and the buyer have acquired and mutually agreed to various information of the real estate for sale and the agreement terms, and proceed to prepare the agreement.

As the operation of the real estate transaction platform (1000) in the present invention only requests minimal personal information (including, but not limited to, name and contact details) upon their registration, the “agreement information” refers to the information additionally requested for the preparation of the agreement, which may include without limitation the addresses of the seller and the buyer.

On the other hand, in the event that the seller and the buyer fail to achieve a mutual agreement, either the seller's terminal (10) or the buyer's terminal (20) may request the main server to process the rupture of the negotiations and the generated chatting room may be closed.

The processing of the “seller's personal information,” the “buyer's personal information,” the “agreement information,” and the “information of a specific real estate for sale” by the main server and the provision of a modifiable electronic agreement to the seller's terminal (10) and the buyer's terminal (20) may be the step (700) where the main server automatically inputs the seller's and the buyer's personal information, agreement information (address) and the specific real estate for sale in the slots (empty spaces) in the standardized agreement and provides the seller and the server with the electronic agreement.

Moreover, the main server (50) may access the public server (60) to receive “register information of the real estate for sale” to process such information together with “the seller's and the buyer's personal information” and the “information on specific real estate for sale” for the generation of the electronic agreement.

On the other hand, the seller and the buyer may amend or add special terms to the electronic agreement provided by the main server (50) and link the said electronic agreement to the chatting room to inquire appropriate advice from the manager, who may be a platform operator or a qualified realtor, for legal reviews.

Whereupon the operation of the real estate transaction platform in the present invention solves the problems of the seller and the buyer to prepare a professional agreement and, at the same time, prevent any legal problems from occurring due to unprofessional amendments to the agreement by allowing the intervention of the manager as necessary.

Furthermore, the modifiable electronic agreement with the date of the provisional and the main agreement may be provided according to the real estate transaction situations and the following review of the electronic agreement (800), signing of the agreement (900), and the issuance and the save of the transfer confirmation slip (910) may be provided for both provisional and main agreements.

The primary review of the electronic agreement in the main server (50) using an automatic review program and the request for secondary review to the manager's terminal (30) for the provision of the results of the review to the buyer's terminal (20) upon the request of the buyer's terminal (20) for the review of the said electronic agreement to the main server may refer to the step (800) where the electronic agreement may be professionally reviewed at the discretion of the buyer.

On the other hand, the main server (50) may request the payment of an additional fee for the professional review through the buyer's terminal (20).

The step above is intended to prevent the problem of “antisocial problems including, but not limited to, double agreements and unreasonably high lease deposits.” First, the main server (50) uses the preinstalled automatic review program to analyze the existing lease deposit set on the real estate for sale, unreasonably high lease deposit, and double agreements to filter any possibilities of occurrence of legal problems. Second, the manager (qualified realtor, etc.) may review the agreement to notarize that the agreement has no legal problems.

The receipt of the “credential information” by the main server (50) from the seller's terminal (10) and the buyer's terminal (20), the credential process, and the conclusion of the contract after the parties' signatures are affixed by the seller's terminal (10), and the buyer's terminal (20) may refer to the step (900) where the system performs a strong credential verification against the seller and the buyer and the parties sign and conclude the legally reviewed electronic agreement.

First, the seller and the buyer may transmit the “credential information” to the main server (50) using the seller's terminal (10) and the buyer's terminal (20), and the “credential information” in this case may be the parties' ID card or driver's license. The main server (50) uses an image and letter recognition program to save the data on the facial photographs, thumbprint information, and the letters (name, ID numbers, addresses) stated on the ID card or the driver's license. Then the server will transmit the credential data to the public server (60), and the seller's and the buyer's personal information will be verified by administrative institutions or personal information verification institutions. Lastly, the authenticity of the electronic agreement will be verified by comparing the information on the electronic agreement with the verified credential data.

Furthermore, the main server (50) may request the seller's terminal (10) and the buyer's terminal (20) to perform mobile authentication, in which case the seller and the buyer will verify that the phone numbers recorded in the personal information are indeed their own numbers using the mobile authentication program.

After the credential process is complete, the seller and the buyer will affix an electronic signature or upload the image files for their seals onto the electronic agreement in the application to conclude the agreement.

On the other hand, the main server (50) may analyze the authentication of the signature (handwriting recognition) for the legal stability of the agreement. In the event that the seller and the buyer affixed their seals, the main server (50) may request the seller's terminal (10) and the buyer's terminal (20) to upload the documents necessary to issue the certificate of seal impression, which will then receive the certificate of seal impression from the authorities to verify the authenticity of the seals.

The issuance and the save of the transfer confirmation slip by the main server (50) upon the transmission of the messages of the buyer's terminal (20) requesting the confirmation of payment to the seller's terminal (10) through the main server, and the confirmation thereof in the seller's terminal (10) may refer to the step (910) where, in the event that the buyer transfers the transaction amount (including, but not limited to, deposits, middle payments, and balances) to the seller's accounts and requests the seller to confirm the receipt of the said amount, the seller confirms the receipt thereof and prepares the receipt on the application (service of the receipt statement). Furthermore, after the seller confirms the receipt of the said amount, the main server (50) issues the transfer confirmation slip and saves it in the database (which the seller and the buyer may download at any time in the form of an image file).

Thereupon, the operation of the real estate transaction platform (1000) in the present invention alleviates the risk of transferring a large amount of transaction money through a third party account (for example, the account of a qualified realtor), and as the transfer confirmation slip verified by the manager is issued by a simple confirmation of the receipt by the seller, the buyer may omit the inconvenience of having to receive a separate evidentiary material from the financial institutions.

The receipt of the “registration application data” by the main server (50) from the seller's terminal (10) and the buyer's terminal (20) and the notification of the completion of the registration may refer to the step (920) where the manager receives the registration application data provided by the seller and the buyer through the main server (50) to apply for the registration with the registrar as a proxy and subsequently notifies the seller and the buyer of the completion of the said registration through their respective terminals.

On the other hand, the first modification of the real estate transaction platform (2000) in the present invention further comprises the following steps:

The uploading of the conditions of the real estate of interest from the buyer's terminal (20) to the main server (50) may refer to the step (300-1) where the buyer enters into the main server (50) the information about the real estate that he/she wishes to contract. In detail, the buyer may upload the information about the address, the level, and the room number of the real estate and the agreement terms (including, but not limited to, the sales agreement, lease agreement, jeonse agreement, sales amount, rent amount, and deposit amount), administrative information on the real estate he/she is interested, including, but not limited to, the confirmation of resident household and register information, and the information on various amenities and facilities (furnishing of air conditioners, washing machines, furniture and parking lots) to the main server (50).

The uploading of the conditions for the interested area from the buyer's terminal (20) to the main server (50) may refer to the step (400-1) where the buyer enters into the main server (50) the information about the area that the real estate he/she wishes to contract. In detail, the buyer may upload onto the main server (50) the information about the surrounding areas of the place the real estate of his/her interest is located, including, but not limited to, the natural environment (information about the rivers, seas, and mountains in the vicinity), education of the children (information about the schools and school districts in the vicinity), property development (information about the new towns, redevelopments, rural areas), transportation (information about the location and the number of subway stations and bus stops in the vicinity), and the neighborhood facility (information about the types and the number of cafés, restaurants, and shopping malls in the vicinity).

The recommendation of the real estate for sale within the area where the buyer is currently located after the main server (50) analyzes the information of the current location of the buyer's terminal (20) may refer to the step (500-1) where the platform, which sends and receives the buyer's location in real-time (apprehends the buyer's location in real-time using the GPS module of the buyer's terminal), recommends the real estate for sale within the area the buyer is currently located that match the conditions of the real estate of interest the buyer had uploaded earlier.

Thereupon, the operation of the real estate transaction platform (1000) in the present invention automatically recommends the real estate for sale that correspond to the conditions that the buyer prefers even if the buyer does not enter the conditions during his/her daily life, the platform increases the possibility of successful contract by recommending the real estate in a state in which the buyer has directly experienced and recognized the surrounding environments. On the other hand, the main server (50) may use the push notification in the buyer's terminal to recommend the real estate for sale, and in the event that there are multiple real estate, then the main server (50) may provide the recommendation in the form of a list of real estate for sale.

In detail, the main server (50) may recommend a specific real estate for sale by matching the conditions uploaded from the buyer's terminal (20) with the real estate for sale uploaded by the seller's terminal (10) within an area with a certain radius from the location that the buyer is currently located. In such case, the buyer may use the buyer's terminal (20) to select whether to recommend the real estate for sale when all or a part of the conditions of the real estate for sale uploaded by the seller matches with the conditions of the real estate of interest uploaded by the buyer. In addition, in consideration of the user convenience, the buyer's terminal (20) may upload a certain radius value to the main server (50) together with the conditions for the real estate of interest. In other words, the first modification of the real estate transaction platform (2000) in the present invention allows the buyer to adjust the area of recommendation of the real estate to the area around the current buyer's location within the radius set by the buyer (for example, the main server recommends real estate within 1 km from the current buyer's location that coincide with the conditions set by the buyer).

Moreover, the buyer's terminal (20) may consent to the collection of the location information of the buyer's terminal (20) by the main server (50) in real-time. In other words, the real estate transaction platform (1000) in the present invention allows the buyer to determine the time the terminal transmits his/her location information, and the main server recommends the real estate for sale in the area in order to prevent continuous recommendation alarm from giving the buyer fatigue and reducing the continuous exposure of the buyer's location information.

Thereupon, the buyer may normally live his/her life without receiving recommendation alarms and receive recommendations on real estate of interest by transmitting the location information to the main server (50) only when the buyer is located in the area of his/her preference.

On the other hand, the second modification of the real estate transaction platform (3000) in the present invention further comprises the following steps:

The uploading of the real estate purchase data and the buyer's ‘My Data’ from the buyer's terminal (20) to the main server (50) may refer to the step (300-2) where the buyer enters the information about the real estate for sale that he wishes to contract (purchase) into the main server (50) and consents to the utilization of ‘My Data’ that records the buyer's consumption patterns.

For example, the buyer may upload the real estate purchase data including, but not limited to, the information about the address, the level, and the room number of the real estate and the agreement terms (including, but not limited to, the sales agreement, lease agreement, jeonse agreement, sales amount, rent amount, and deposit amount), administrative information on the real estate he/she is interested, including, but not limited to, the confirmation of resident household and register information, and the information on various amenities and facilities (furnishing of air conditioners, washing machines, furniture and parking lots) to the main server (50).

Moreover, the buyer may provide the buyer's ‘My Data,’ a dataset containing the buyer's consumption history, to the main server (50). The buyer's ‘My Data’ may include, without limitation, the information about the purchase categories (categories of the items or services provided), sellers, time, frequency, and payment amount.

The transmission of the list of the recommended real estate for sale generated using the real estate for sale data, real estate purchase data, and the ‘My Data’ of the buyer from the main server (50) to the buyer's terminal (20) may refer to the step (400-2) where the platform curates the list of the recommended real estate for sale which has been optimized for the buyer using the real estate for sale data obtained from the seller and the real estate purchase data and ‘My Data’ obtained from the buyer.

In such a case, the main server may match the real estate for sale data and the real estate purchase data to generate a preprocessed list of real estate for sale and further establish the order of priority on the real estate in the preprocessed list using the buyer's ‘My Data.’

In detail, the main server may match multiple categories from the real estate for sale data and the real estate purchase data and select the real estate with high degrees of similarities to generate the preprocessed list of real estate for sale. This is a service also provided in the existing real estate transaction platforms, and it can be said as a publicly known art that is not differentiated.

However, the operation of the second modification of the real estate transaction platform (3000) in the present invention may complete the list of recommended real estate for sale by establishing the priority among the real estate in the preprocessed list using the buyer's ‘My Data.’ The meaning of the establishment of the priority among the real estate for sale by the application of the ‘My Data’ of the buyer may include, without limitation, the recognition of the real estate for sale with higher importance as the real estate with the higher priority to provide such at the top of the first page of the list of the recommended real estate for sale, or the recognition of the real estate for sale with lower importance as the real estate with the lower priority to remove them completely from the list of the recommended real estate for sale.

In detail, the main server (50) extracts preferred purchase categories from the buyer's ‘My Data’ and establishes the order of priority on the preprocessed list of the real estate for sale based on either or both the number and the real estate of sellers corresponding to the preferred purchase categories and/or the seller (may be limited to the sellers located in the vicinity of the real estate for sale) corresponding to the preferred purchase categories.

In other words, first, the main server (50) may use the buyer's ‘My Data’ to extract his/her preferred purchase category (for example, the buyer prefers coffee); and in this case, there may be multiple preferred purchase categories. Then, the main server sets up the vicinity using the address of the real estate for sale in the preprocessed list (for example, the vicinity is set to 100 m from the address of the real estate for sale) and may judge the importance by putting a weight on either or both the number and the real estate of sellers corresponding to the preferred purchase categories and/or the seller (may be limited to the sellers located in the vicinity of the real estate for sale) corresponding to the preferred purchase categories. For example, the main server may establish the order of the priority by putting high importance on the number of sellers corresponding to the preferred purchase category in the vicinity; similarly, the main server may establish the order of the priority by putting high importance on the distances (in the event that there are multiple sellers, then their average distances) to the sellers corresponding to the preferred purchase category. The main server may also index the value of the first results and assign higher values for the larger number of the sellers, index the value of the second results and assign higher values for closer proximity to the sellers, and establish higher importance on the articles with the higher arithmetic sum of the values of the first and second results.

Furthermore, the main server (50) may assign the order of priority of the real estate for sale by receiving the seller's ‘My Data’ from the seller's terminal (for example, kiosks installed in cafés), extracting the popular sales categories from his/her ‘My Data,’ and matching such popular sales category with the preferred purchase category extracted from the buyer's ‘My Data.’ In other words, the main server (50) may reflect the buyer's preferred purchase category and the popular sales categories that the seller frequently sells as the popular items. For example, the buyer likes coffee. The first seller sells the coffee and hamburgers together, and his coffee is the more popular item. The second seller sells the coffee and hamburgers, and his hamburger is the more popular item. In such a case, the server may, without limitation, recommend the real estate for sale that has more number of the first seller or is closer to the first seller.

In detail, the main server (50) establishes the order of priority on the preprocessed list of the real estate for sale based on either or both the number and the real estate of sellers with the popular sales categories that match the preferred purchase categories and/or the shorter distance to the seller (may be limited to the sellers located in the vicinity of the real estate for sale) with the popular sales categories that match the preferred purchase categories.

In other words, first, the main server (50) may use the seller's ‘My Data’ to extract the popular sales category (for example, if the coffee is the best-selling item at a café with various sales categories, then the coffee is established as the popular sales category); and in this case, there may be multiple popular sales categories. Then, the main server sets up the vicinity using the address of the real estate for sale in the preprocessed list (for example, the vicinity is set to 100 m from the address of the real estate for sale) and may judge the importance by putting a weight on either or both the number and the real estate of sellers with the popular sales categories that match the preferred purchase categories and/or the shorter distance to the seller (may be limited to the sellers located in the vicinity of the real estate for sale) with the popular sales categories that match the preferred purchase categories. For example, the main server may establish the order of the priority by putting high importance on the number of sellers with popular sales categories that match the preferred purchase category in the vicinity; similarly, the main server may establish the order of the priority by putting higher importance on the distances (in the event that there are multiple sellers, then their average distances) that are closer to the sellers with the popular sales category that matches the preferred purchase category. The main server may also index the value of the first results and assign higher values for the larger number of the sellers, index the value of the second results and assign higher values for closer proximity to the sellers, and establish higher importance on the articles with the higher arithmetic sum of the values of the first and second results.

The selection of specific real estate for sale from the buyer's terminal (20) from the list of recommended real estate may refer to the step (500-2), where the buyer selects specific real estate for sale that he/she wishes to purchase from the list of recommended real estate for sale provided by the platform. The specific real estate for sale selected from the buyer's terminal (20) may be saved and recorded in the main server's database (50).

On the other hand, the third modification of the real estate transaction platform (4000) in the present invention further comprises the following steps:

The request by the buyer's terminal (20) to the main server (50) for, and the receipt of, the list of the real estate for sale and selection of specific real estate for sale may refer to the step (300-3) where the buyer enters into the main server (50) the information about the real estate he wishes to contract, receives the list of corresponding real estate for sale and chooses specific real estate from the said list.

For example, the buyer may transmit the information about the real estate of his/her interest, including, but not limited to, the information about the address, the level, and the room number of the real estate and the agreement terms (including, but not limited to, the sales agreement, lease agreement, jeonse agreement, sales amount, rent amount, and deposit amount), administrative information on the real estate he/she is interested, including, but not limited to, the confirmation of resident household and register information, and the information on various amenities and facilities (furnishing of air conditioners, washing machines, furniture and parking lots), to the main server (50), receive a list of real estate for sale corresponding to the conditions above and choose specific real estate.

The establishment of the date, time, and venue of the visit by the seller's terminal (10) and the buyer's terminal (20) through the main server (50) may refer to the step (400-3) where the seller and the buyer mutually agree on the date, time, and venue of the visit. The seller and the buyer may exchange their opinions and establish the date, time, and venue of the visit using the program provided by the main server (50) on the seller's terminal (10) and the buyer's terminal (20). For these purposes, the main server (50) may generate a chatting room that can be accessed by the seller's terminal (10) and the buyer's terminal (20), and the seller and the buyer may send and receive the text, voice, and video messages through the chatting room. On the other hand, the venue of the visit is generally, but not limited to, the location of the real estate for sale, and it may also be, for example, a café or a meeting room in the vicinity of such real estate for sale. The date, time, and venue of the visit established by the seller and the buyer may be recorded and saved in the main server's database (50).

The main server's (50) provision of the location information of the buyer to the seller's terminal (10), or the location information of the seller to the buyer's terminal (20), or both, for a certain time around the time of visit, may refer to the step (500-2) where the platform provides the information of the location of the counterpart to either the seller or the buyer or both for real-time monitoring on the app or web for a certain time around the time of visit (for example, it may be from a certain time to the time of visit, but it is not limited to the foregoing).

Thereupon, in the event that either party or both party fails to visit despite their prior promise, the third modification of the real estate transaction platform (4000) in the present invention minimizes the damages occurring from a no-show in the direct transaction between the seller and the buyer by identifying the locations of the counterpart and becoming aware of such event in advance.

In this case, a certain time value may be determined by the request of the seller's terminal (10) or the buyer's terminal (20), or both. In other words, the duration to provide the information of the location of a party or both parties to the counterpart may be determined by a unilateral request of the seller and/or the buyer or under the agreement of both parties. For example, in the event where both the seller and the buyer are located in a remote place, the seller and the buyer may establish the duration of the location information about the counterpart is provided from three hours before the time of visit to the time of visit; on the contrary, in the event where both the seller and the buyer have located nearby the venue, such duration may be established from thirty minutes before the time of visit to the time of visit.

Moreover, in the event where either seller or the buyer or both break away from a certain distance from the venue of visit for a certain time around the time of visit, the main server (50) may trigger an alarm on either the seller's terminal (10) or the buyer's terminal (20) or both. In other words, in the event that either the seller or the buyer, or both break away from a certain distance from the venue of visit for a certain time around the time of the visit, and therefore such breakaway party or parties have little possibility of arriving at the venue of visit at the time of visit, the third modification of the real estate transaction platform (4000) in the present invention triggers a warning alarm (the alarm may be provided in the form of a push notification on the seller's and the buyer's terminals) on either the seller or the buyer, or both, and causes the parties to become aware of a possibility of a no-show by the counterpart.

In this case, the certain distance value may be determined by request of the seller's terminal (10) or the buyer's terminal (20), or both. In other words, the minimum distance from the venue of the visit that will trigger the alarm on a party or both parties may be determined by a unilateral request of the seller and/or the buyer or under the agreement of both parties. For example, the seller and the buyer may set to trigger the alarm if the counterpart fails to be within 1 km from the venue of the visit until 1 hour prior to the time of visit.

Furthermore, the main server (50) may support a video call on the seller's terminal (10) and the buyer's terminal (20) if the distance between the seller and the buyer is less than a set distance for a certain period around the time of visit. In this case, the main server (50) may analyze the coincidence of the image of the seller in the video call and the image of the ID card found in the personal information of the seller and send the results thereof to the buyer's terminal (20); likewise, the main server (50) may analyze the coincidence of the image of the buyer in the video call and the image of the ID card found in the personal information of the buyer, and send the results thereof to the seller's terminal (10).

In other words, the third modification of the real estate transaction platform (4000) in the present invention allows the video call and recognition of the seller's and the buyer's faces only if the seller and the buyer are in proximity. If the video call is allowed in a state where the seller and the buyer are not in proximity, either the seller or the buyer or both may not proceed with the real estate transaction and use the counterpart's image in various frauds and sexual crimes.

Moreover, the third modification of the real estate transaction platform (4000) in the present invention allows the main server (50) to compare the images of the seller and the buyer, which have been naturally collected during the video call with the images of the ID card both parties had uploaded earlier in order to check if the parties to the transaction are indeed the seller and the buyer. In such a case, the seller and the buyer may omit the cumbersome process of exchanging their ID cards and verifying whether they are the actual seller and buyer in the transaction. The third modification of the real estate transaction platform verifies their identities through scientific judgment. On the other hand, artificial intelligence may be used to judge the images; for example, the tools used may include but are not limited to the artificial intelligence trained using singularity judgment data.

The present invention described above can be realized into a program (or an application) intended to be combined and executed with the hardware—the server—and saved in storage media.

The program above may comprise the codes codified using the computer languages, including, but not limited to, C, C++, JAVA, and machine languages, which may be read by the central processing unit (CPU) of the computer using the computer's device interfaces in order to read the program and execute the methods realized using the program. Such codes may comprise the functional codes related to the functions that define the features needed to execute the methods above and may comprise the control codes related to the execution procedures needed to allow the CPU of the computer to execute the features according to the prescribed procedures. Moreover, such codes may further comprise the memory reference codes related to the reference of the additional information or media necessary for the CPU of the computer to execute the features above to a certain location (address) in the internal or external memory of the computer. In addition, in the event that the CPU of the computer requires communication with other remote computers or servers to execute the features above, such codes may further comprise the communication codes that define the method of communication with other remote computers or servers using the communication module of the computer and the type of communicated information or media.

In the operation of the real estate transaction platform in the present invention, the seller and the buyer directly enter into a contract. Managers (administrators, qualified realtors, etc.) will only be able to specifically intervene when needed in the chatting rooms or during the agreement reviews to review legal matters; hence, the present invention is advantageous that it supports direct real estate transactions between the seller and the buyer in a legally safe manner.

Moreover, in the operation of the real estate transaction platform in the present invention, the electronic agreement is automatically provided based on the seller's and the buyers' personal information and the information of the real estate for sale uploaded by the seller; hence, it relieves the inconvenience of the formalities performed between the non-professionals.

Furthermore, in the operation of the real estate transaction platform in the present invention, if the buyer directly transfers the amount to the seller's account, produces a receipt in the application, and requests the seller for confirmation, the seller will affix his/her signature on the receipt which will then be saved as a proof of transfer. Therefore, the present invention makes the transaction safe by removing the need to use a third party (the qualified realtor's) account, and at the same time provides easy and convenient transfer process.

The advantageous effect of the present invention is not limited to the effect stated above, and one having ordinary skill in the art will be able to clearly understand the other unmentioned effect through the descriptions written below.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A method of real estate transaction platform that supports the direct transaction between the seller and buyer, comprising:
the transmission of the seller's and the buyer's personal information from their terminals to the main server;
the uploading of the information of the real estate for sale from the seller's terminal onto the main server;
the request of the buyer's terminal to the main server for the information of the real estate for sale and the receipt of such information;
the selection of the information of specific real estate for sale from the buyer's terminal from the list of the real estate for sale;
the generation of a chatting room by the main server for the seller's and the buyer's terminals;
the transmission of the agreement information from the seller's and the buyer's terminals to the main server and the request of the contract process;
the processing of the seller's and the buyer's personal information and the information of the specific real estate for sale by the main server and the provision of a modifiable electronic agreement to the seller's and the buyer's terminals;
the primary review of the electronic agreement in the main server using an automatic review program and the request of secondary review to the manager's terminal for the provision of the results of the review to the buyer's terminal upon the request of the buyer's terminal for the review of the said electronic agreement to the main server;
the receipt of the credential information by the main server from the seller's and the buyer's terminals, the credential process, and the conclusion of the contract after the seller's and the buyer's signatures are affixed by their respective terminals; and
the issuance and the save of the transfer confirmation slip by the main server upon the transmission of the messages of the buyer's terminal requesting the confirmation of payment to the seller's terminal through the main server and the confirmation of the transfer in the seller's terminal.
The main server accesses the public server in the step where the buyer's terminal requests the main server the information of the real estate for sale and receives the social safety index corresponding to the location of the real estate for sale, which will then be provided to the buyer's terminal. The seller and the buyer will request to disclose their mobile phone number and establish the visit schedule through the chatting room, and the date of the visit will be automatically recorded in the calendars of their terminals. The main server accesses the public server to receive the registered information of the real estate for sale, processes the said information along with the seller's and the buyer's personal information and the information of the specific real estate for sale, and subsequently provides the electronic agreement to the seller's and the buyer's terminals. The main server performs the primary mobile authentication in the step where the seller's and the buyer's terminals transmit their respective personal information. In the step where the main server authenticates the credential information in the ID card, or the driver's license received from the seller's and the buyer's terminals, the main server accesses the public server to authenticate the credential information with the information from the administrative institutions or the personal information authentication institutions and compares the verified information with the information recorded in the electronic agreement.

2. The method in according to claim 1,
Wherein the step where the main server receives registration application data from the seller's and the buyer's terminals and notifies the completion of the said application is added to the operation method of the real estate transaction platform that supports the direct transaction between the buyer and the seller.
